(19) United States
(12) Patent Application Publication
(10) Pub. No.: US 2023/0316403 A1
(43) Pub. Date: Oct. 5, 2023

(54) SYSTEM AND METHOD FOR ASSESSMENT OF CRYPTO AND DIGITAL ASSESTS

(71) Applicant: SIDHARTH NARESH SOGANI, MUMBAI (IN)

(72) Inventor: SIDHARTH NARESH SOGANI, MUMBAI (IN)

(21) Appl. No.: 18/005,860

(22) PCT Filed: Jul. 13, 2021
(86) PCT No.: PCT/IB2021/056277

§ 371 Date: Jan. 18, 2023

(30) Foreign Application Priority Data
Jul. 22, 2020 (IN) 202021031383

(51) Int. Cl. G06Q 40/06

(52) U.S. Cl. CPC G06Q 40/06; G06Q 2220/00

(57) ABSTRACT

A system for assessment of digital assets is disclosed. The system includes a digital asset data collection module to collect information corresponding to data parameters associated with the digital assets from several source data points. The system includes a digital asset data maintenance module to store the information collected by the digital asset data collection module into a blockchain. The digital asset data maintenance module updates the information stored in the blockchain dynamically using learning-based data upgradation techniques and external sources. The system includes a data assessment module to assess the information stored in the blockchain to obtain a plurality of research products. The data assessment module generates a machine assessment score based on the information assessed. The system includes a digital asset score generation module to generate an aggregated score by receiving the machine assessment score generated by the data assessment module and user assessment scores.

### CROSS-REFERENCE TO RELATED APPLICATION

This Application claims priority from a Patent application filed in India having Patent Application No. 202021031383, filed on Jul. 22, 2020. and titled “SYSTEM AND METHOD FOR ASSESSMENT OF CRYPTO AND DIGITAL ASSESTS” and a PCT Application No. PCT/IB2021/056277 filed on Jul. 13, 2021, and titled “SYSTEM AND METHOD FOR ASSESSMENT OF CRYPTO AND DIGITAL ASSESTS.”

### BACKGROUND

Embodiments of the present disclosure relate to a Blockchain, cryptocurrency industry and emerging technology industry and more particularly to a system and a method for assessment of crypto and digital assets.

Blockchain and cryptocurrency industry is at its nascent stage and there was a need to bring more transparency and trust while evaluation and assessment of emerging technologies and projects. Given the pace of development of the companies’ operations with crypto and digital assets are an objective inevitability for most state. The crypto assets are the assets stored on distributed ledgers and Blockchains. This includes all cryptocurrencies as well as non-currency assets such as security tokens, utility tokens or the like. The underlying technology of digital assets is referred to as blockchain or distributed ledger technology, and it has propelled the growth of the crypto and digital asset market. Such crypto and digital asset market is avant-garde and business plans so different than traditional business enterprises that it has created a need to reconsider the definitional concepts of revenue, expenses, capital, taxable income, profit, shareholders, stakeholders and value identification to name only a few.

Traditional assessment parameters which were used to understand a project’s market standing and credibility are outdated and cannot be applied to emerging technology ecosystem. This industry and technology are global in nature Also, there are no systematic processes to analyze and rate any blockchain or crypto and digital assets at the moment which uses unique method tailored specially keeping in mind the industry requirements. The current processes which are available for rating and other assessment based, research or analytical products, do not cover this emerging technology of blockchain. They are more focused on traditional assets such as shares, stocks commodities or the like.

Hence, there is need for an improved system and method for assessment of crypto and digital assets to address the aforementioned issues.

### BRIEF DESCRIPTION

In accordance with an embodiment of the present disclosure, a system for assessment of crypto and digital assets is provided. The system includes a processing subsystem hosted on a server. The processor includes a digital asset data collection module configured to collect information corresponding to a plurality of data parameters associated with the one or more crypto and digital assets from a plurality of source data points to create a database. The processor also includes a digital asset data maintenance module configured to store the information collected by the data collection module into a blockchain. The digital asset data maintenance module is also configured to update the information stored in the blockchain dynamically using a plurality of learning based data upgradation techniques and a plurality of extemal sources. The processor further includes a data assessment module configured to assess the information, updated by the data maintenance module, stored in the blockchain to obtain a plurality of research products and a plurality of other products. The data assessment module is also configured to generate a machine assessment score based on the information assessed. The processor further includes a digital asset score generation module configured to generate an aggregated score by receiving the machine assessment score generated by the data assessment module and one or more user assessment scores.

In accordance with an embodiment of the present disclosure, a method for assessment of crypto and digital assets is provided. The method includes collecting, by a crypto asset data collection module, information corresponding to a plurality of data parameters associated with the one or more crypto and digital assets from a plurality of source data points to create a database. The method also includes storing, by a digital asset data maintenance module, the information collected by the data collection module into a blockchain. The method further includes updating, by the digital asset data maintenance module, the information stored in the blockchain dynamically using a plurality of learning based data upgradation techniques and a plurality of external sources. The method further includes assessing, by a data assessment module, the information, updated by the data maintenance module, stored in the blockchain to obtain a plurality of research products and a plurality of other products. The method further includes generating, by the data assessment module, a machine assessment score based on the information assessed. The method further includes generating, by a digital asset score generation module, an aggregated score by receiving the machine assessment score generated by the data assessment module and one or more user assessment scores.

To further clarify the advantages and features of the present disclosure. a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system for assessment of crypto and digital assets in accordance with an embodiment of the present disclosure,

FIG. 1(a) is a block diagram representation of one embodiment of the system of FIG. 1, depicting research products and other products in accordance with an embodiment of the present disclosure;

FIG. 2 is a schematic representation of an exemplary system for assessment of crypto and digital assets of FIG. 1 in accordance with an embodiment of the present disclosure:

FIG. 3 is a block diagram of a computer or a server in accordance with an embodiment of the present disclosure; and

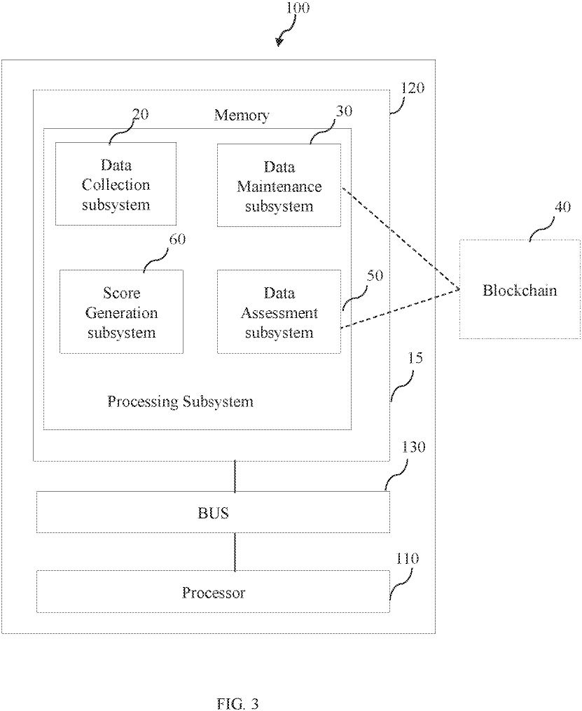

FIG. 4 is a flow chart representing the steps involved in a method for assessment of crypto and digital assets of FIG. 1, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises... a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and a method for assessment of crypto and digital assets is provided. The system includes a processing subsystem hosted on a server. The processing subsystem includes a digital asset data collection module configured to collect information corresponding to a plurality of data parameters associated with the one or more crypto and digital assets from a plurality of source data points to create a database. The processor also includes a digital asset data maintenance module configured to store the information collected by the data collection module into a blockchain. The digital assets use cryptography and can also be called crypto assets. A digital asset may not use cryptography but is still a digital asset. As used herein, “digital asset, in essence, is anything that exists in a binary format and comes with the right to use. The digital assets include but are not exclusive to: digital documents, audible content, motion picture, and other relevant digital data that are currently in circulation or are, or will be stored on digital appliances such as: personal computers, laptops, portable media players, tablets, storage devices, telecommunication devices, and any and all apparatuses which are, or will be in existence once technology progresses to accommodate for the conception of new modalities which would be able to carry digital assets. The asset data maintenance module is also configured to update the information stored in the blockchain dynamically using a plurality of learning based data upgradation techniques and a plurality of external sources. The processor further includes a data assessment module configured to assess the information, updated by the data maintenance module, stored in the blockchain to obtain a plurality of research products and a plurality of other products. The data assessment module is also configured to generate a machine assessment score based on the information assessed. The processor further includes a digital asset score generation module configured to generate an aggregated score by receiving the machine assessment score generated by the data assessment module and one or more user assessment scores.

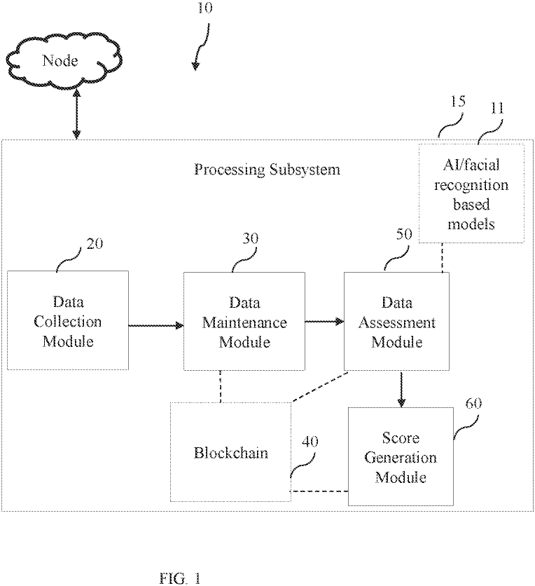

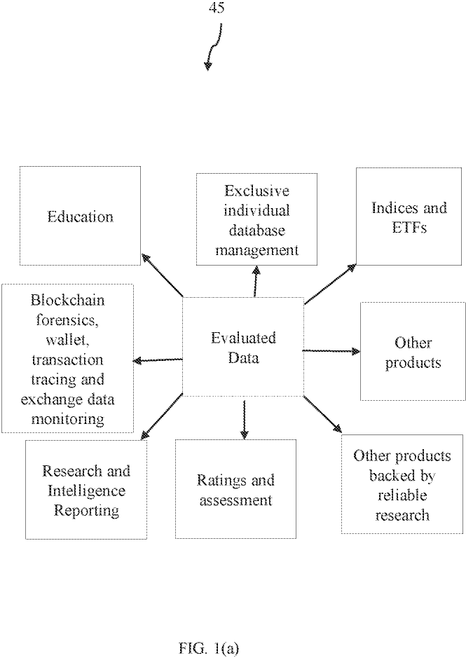

FIG. 1 is a block diagram representation of a system 10 for assessment of crypto and digital assets in accordance with an embodiment of the present disclosure. The system 10 includes a processing subsystem 15 hosted on a node. In one embodiment, the node may include a centralized platform, decentralized platform or a server 25. In such an embodiment, the server may be a local server. In another embodiment, the server may be a cloud server. The processing subsystem 15 includes a digital asset data collection module 20 to collect information corresponding to multiple data parameters associated with the one or more crypto and digital assets from source data points to create a database. In another embodiment, the multiple data parameters associated with the one or more digital assets may be collected resources such as human resources. As used herein, the digital assets are the digital currency or non-currency assets of any organisation. The digital asset is a digital asset designed to work as a medium of exchange wherein the digital assets are stored in a digital ledger or computerized database using strong cryptography to secure transaction record entries, to control the creation of additional digital records, and to verify the transfer of ownership. In one embodiment, the one or more digital assets may include at least one of legal information, financial information, technology information, funding information, due diligence information, trade information or a combination thereof. In a specific embodiment, the multiple data parameters may include at least one of legal parameter. team related parameter, token economics related parameter, general project related parameter, funding information related parameter, market and industry analysis related parameter, technology and trade information related parameter, organization project related parameter or a combination thereof.

In such an embodiment, the legal parameters may include at least one of a country of incorporation of the digital assets, year of incorporation of digital assets, number of founders, dispute resolution/ governing law, possible venue of arbitration, registration number, registered address and incorporated address, AML check, country risk assessment, auditors or agents, participation restriction, company type, last updated, capital, take overs, annual return filing date, company status, over view and analysis or a combination thereof. In another embodiment, the team related parameters may include at least one of name of director, nationality, education, date of birth, projects associated, projects performances, experience and past, address, skillset, social media accounts, interview comments, testimonials, dark web search, flagged wallets or associations, interview and assessment of the director, Blockchain forensics associations or a combination thereof.

In a specific embodiment, the token economics related parameters may include at least one of a token code, a type, number of coins issued as per contact, total holders, total supply, total circulation, volume, exchanges, pairs, trapped transactions, flagged wallet associations, a listing price, a current price as on, region of interest, charts, Bot analysis, volume analysis, EMA, RSI, MACD, flow index, parabolic SAR. trend line analysis, VPVR, MA, historic trading volumes. Bollinger, Chainkin, money flow index or a combination thereof. In another embodiment, the general project related parameters may include at least one of a website, social media handles, information links, major PR coverage, phone, contact address, contact person, deep web search or a combination thereof.

In one embodiment, the funding information related parameters may include at least one of a number of token issued, equity funding, hard cap, small cap, total raised, next round, statistics date/end date, VC equity, PE equity, vesting, ESOPs, holding structures, overview and analysis or a combination thereof. In another embodiment, the market and industry analysis parameters may include at least one of market size, market cap/share, success of similar projects, edge over other projects, market size to country, market size to region, market size global, project size/market cap, equity valuation, market valuation, potential for growth or a combination thereof.

In yet another embodiment, the technology and trade information parameter may include at least one of SSL type, DNS analysis, DDoS protection, X-frame options, strict transport security, X-content type options, X-XSS protection, vulnerable libraries, do not expose server information, application security protection, content security policy, public key pins, API and API to other exchanges for volumes, server location, server location IP information, server location DB-IP, domain name registration and location, ping rate, transfer or withdrawal limits, language supported, number of markets, OTC market, number of coins listed, volumes objectionable coins, artificial pumps of coins, leverage trading, leverage trading pairs, fiat support, de-listing of coins, tether and exchanges coin support, user interface, matching speed, algorithm support, trading charts, candle sticks, withdrawal fees of major coins, type of wallets-exchange, funding and margin, trading volume, forks, airdrops, volume rank, exchange native token, method of listing, artificial volume generation through Bots, wallets, deposits or non-maintenance fees, backend Bots generating volumes, order spoofing observations, launchpads, projects invested, knowledge base and education centre, website traffic or a combination thereof. In such an embodiment, the project related parameters may include at least one of a company overview, team analysis and operations, number of full and part-time employees, branding standard, additional certifications, speed of the project, road map analysis, growth percentage, whitepaper analysis or a combination thereof.

Furthermore, the processing subsystem 15 includes a digital asset data maintenance module 30 operatively coupled to the data collection module 20. The digital asset data maintenance module 30 stores the information collected by the digital asset data collection module into a blockchain 40. As used herein, the blockchain is a growing list of records, called blocks which is distributed to several nodes who maintain the copy of records, that are linked using cryptography. The blockchain 40 is resistant to modification of the data. The blockchain 40 is an open, distributed ledger that may record transactions between two parties efficiently and in a verifiable and permanent way. In one embodiment, the blockchain 40 may be a public blockchain. The public blockchain allows individuals who do not know each other to trust a shared record of events without the involvement of an intermediary or third party irrespective of the industry type. In another embodiment, the blockchain 40 may be a private blockchain. In the private blockchain participants are known and are granted read and write permissions by an authority that governs the use of the blockchain. For example, the private blockchain participants may belong to the same or different organizations within an industry sector. In various embodiments, these relationships may be governed by informal relationships, formal contracts or confidentiality agreements.

Consequently, the digital asset data maintenance module 30 updates the information stored in the blockchain 40 dynamically using learning-based data upgradation techniques and various external sources. In one embodiment, the learning-based upgradation technique may include at least one of artificial intelligence techniques, machine learning techniques or a combination thereof. In a specific embodiment, the various external sources may include but not limited to at least one of web crawling, feedbacks, manual entry, opinions, polls or a combination thereof.

Moreover, the processing subsystem 15 includes a data assessment module 50 operatively coupled to the digital asset data maintenance module 30. The data assessment module 50 assesses the information, updated by the data maintenance module 30, stored in the blockchain 40 to obtain multiple research products and other products. On embodiment 45 of the multiple research products and the other products is shown in FIG. 1(a). In one embodiment, the multiple research products may include but not limited to at least one of a rating report, a research report, an intelligence report, an educational report, market indices report, on demand service report, a blockchain forensics report related to transaction tracing or a combination thereof. In another embodiment, the other products may include research, intelligence, reporting, auditing, forecasting, other products backed by reliable research or the like. The data may also be used to publish newsletters and informative research articles by several researchers. As used herein, rating report includes a rating which is more of a certification where the system take guarantee of the score. This is mainly research but the system uses the scoring process mentioned in the document for assessment of the score for the same. The research report consists of data from the data source points but is usually not very detailed as the data is rolled out in the public domain for viewing. Hence sensitive information pertaining to the project such as passport, contacts, bank account numbers, or the like are hidden. Only information which is available publicly is aggregated and given. The intelligence report uses the data from the above process plus other surveillance techniques depending on the expertise of the professional human resources deployed. The due diligence report includes a feasibility of the of a project, legal, financial, technology and directors background along with artificial intelligence/facial recognition-based models 11 to verify identity of the individual and provide authentication management. The report is usually for investors who want to verify the whereabouts of a project before investing to make sure it’s not a scam or a project with bad intentions.

In one embodiment, the system includes exclusive individual database which aims at eliminating fake profiles and scammers in the blockchain and crypto industry by using a unique authentication process. The exclusive individual database also aims to verify each profile of the individual who is interested in getting verified. The data is then synced on the blockchain and is used for research, intelligence and due diligence. In one embodiment, the data may be used for users to view the verified profiles. The Blockchain and crypto transactions work using a Merkle tree which is a trace or cryptographic hash of the transactions taking place over several blockchains. As the transactions are pseudonymous in nature meaning no names are attached to it but just a transaction hash and a wallet address is visible on the blockchain. Many illicit activities take advantage of this feature to conduct transactions. These transactions are flagged with known and safe addresses by a blockchain forensics division. For example, wallet A belongs to exchange ‘Alpha’ and wallet B is pseudonymous. When wallet B transfers to wallet A, the system will know that wallet A is a safe wallet because the identity is verified with the exchange. But wallet B is unknown. If anything suspected from this transaction, the system may contact the exchange to get more information about the wallet B as exchanges keep standard KYC with them for all its users.

The market information like prices, circulating supply, authenticity of the project, number of trading pairs and exchanges, etc are used to build systematic weighted indices which are bifurcated sector wise. These indices are similar to exchange traded funds like Sensex or Nifty. The same information is also used to provide custodian services to crypto companies, exchanges and HNIs to safely hold their digital assets and manage them. In one embodiment, the data collected from the multiple data source points may be used to educate and provide research material to researchers, education institutes and government organisations as well.

In a specific embodiment, the data assessment module 50 may verify an integrity of the information stored in the blockchain using a hash validation technique. The data is verified and maintained on the blockchain 40 which makes the information stored more reliable and immutable in nature. The information stored on the blockchain 40 is maintained in several nodes that have the same copy of the previous data. Hence, if there is any attempt of manipulation in the database, all the nodes must accept the change. If the majority of the nodes accept the change, the change is entered in the blockchain, but if not, that attempt is failed. Such mechanism makes the blockchain 40 data immutable because once the data is entered by approval of the majority of nodes, the data cannot be reversed.

Subsequently, the data assessment module 50 generates a machine assessment score based on the information assessed. The information assessed is verified and evaluated by automation which includes automatic scoring methods designed in the rating model. The parameters entered in the model keep changing as per the changes in the industry as per the economic political and financial situations. Such rating is then entered in the projects column and is sent to one or more evaluators for further verification. The data assessment module 50 receives one or more user scores evaluated by the one or more evaluators. The one or more user scores may be evaluated by based on understanding of the one or more evaluator as per expertise and professional skills and enters the score into score column of the data assessment module 50.

In addition, the processing subsystem 15 includes a digital asset score generation module 60 to generate an aggregated score by receiving the machine assessment score generated by the data assessment module 50 and one or more user assessment scores evaluated by the one or more evaluators. In one embodiment, the digital asset score generation module 60 may generate the aggregated score based on a concatenation of the machine assessment score and the one or more user assessment scores. In such an embodiment, the aggregated score may be converted into alphabetical rating chart for an easy understanding of the rating. In a specific embodiment, the digital asset score generation module 60 may calculate a change in the aggregated score based on the information updated by the data maintenance module 50. In one embodiment, the system 10 may be located on a server.

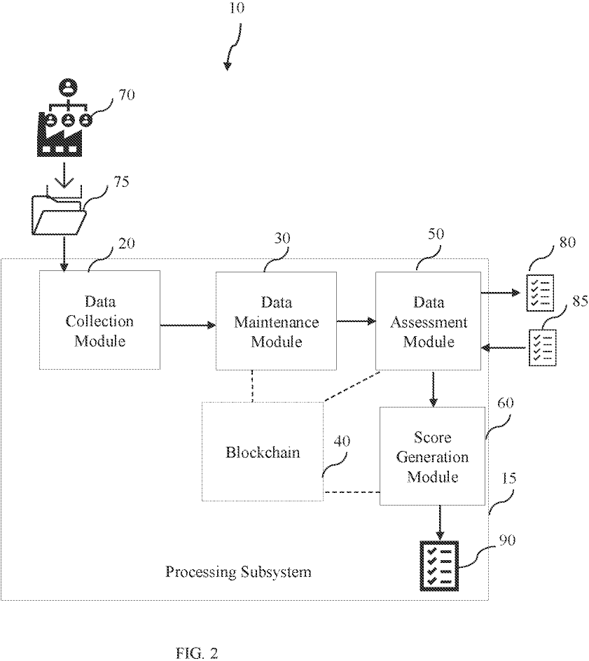

FIG. 2 is a block diagram representation of an exemplary embodiment of the system 10 for assessment of digital assets of FIG. 1 in accordance with an embodiment of the present disclosure. Consider an example where the system 10 analyses the four major aspects for the crypto industry ‘x’ 70 mainly legal, technological, financial and due diligence of the founders and directors of crypto industry ‘x’ 70. The system 10 also uses several other parameters such as country risk assessment, legal jurisdiction, or the like to come to a better conclusion to score a project. In order to score the project, the digital asset data collection module 20 of the system 10 collects the information corresponding the multiple data parameters 75 associated with legal, financial, technological, due diligence information of the crypto industry ‘x’ 70. The digital asset data collection module 20 may collect legal parameter, team related parameter, token economics related parameter, general project related parameter, funding information related parameter, market and industry analysis related parameter, technology and trade information related parameter, organization project related parameter and corresponding sub-parameters of the crypto industry ‘x’ 70.

Upon collecting the information corresponding to the multiple parameters 75, the digital asset data maintenance module 30 of the system 10 stores the information collected by the digital asset data collection module 20 into a blockchain 40. In the blockchain 40, the information is stored by creating blocks of the information which is linked using cryptography. Furthermore, the digital asset data maintenance module 30 updates the information stored in the blockchain 40 dynamically using learning-based data upgradation techniques and various external sources. For example, the digital asset data maintenance module 30 sends a command to the blockchain 40 to update the information by dynamically receiving the information regarding the crypto industry ‘x’ 70 using web crawling. Continuing the above-mentioned example, consider that the director of the crypto industry ‘x’ 70 was ‘Mr. ab’ previously and after few years the director has changed to ‘Mr. cd’. The digital asset data maintenance module 30 updates the blockchain 40 by storing the new information regarding the name of the director of the crypto industry ‘x’ 70.

To validate the information stored in the blockchain 40, the data assessment module 50 of the system 10 assesses the information updated by the data maintenance module 30, stored in the blockchain 40 to score the project. Based on the historic data and training of the artificial intelligence or machine learning models, the data assessment module 50 assesses the information and generates a machine assessment score 80. The machine assessment score 80, for example ‘A’, is entered in a first column of the data assessment module 50. Moreover, the data assessment module 50 receives one or more user scores 85 evaluated by the one or more evaluators. The one or more user scores 85 may be evaluated by based on understanding of the one or more evaluator as per expertise and professional skills and enters the score into score column of the data assessment module 50.

For example, the information is verified and evaluated by 3 evaluators where all 3 evaluators evaluate the project and gives their rating based on their understanding of expertise and professional skills and enters the scores, for example ‘B’, ‘C’ and ‘D’ in second, third and fourth column of the data assessment module 50. Additionally, the digital asset score generation module 60 of the system 10 generates an aggregated score 90 by concatenating the machine assessment score 85 ‘A’ and the one or more user scores 85 ‘B’, ‘C’ and ‘D’ generated by the 3 evaluators. Now the aggregated score 90 has been generated and may be used in various applications and products. Consider an example of legal, technology and finance as major parameters which are evaluated by the digital asset score generation module and 3 human resources as shown in table -1. The aggregated score is calculated by adding the scores from all four resources and take an average from the addition such as 59.1 is the sum of scores by all resources and is divided with 4 (resources of score). The digital asset score generation module generates an aggregated score 14.77 for the category of three categories. The same process may be scaled to as many numbers of parameters.

| Parameters | Score by digital asset score generation module | Human resource 1 | Human resource 2 | Human resource 3 | Total |
|---|---|---|---|---|---|
| Legal | 5 | 6 | 3 | 1 | 15 |
| Technology | 7.5 | 7 | 4 | 2 | 20.5 |
| Finance | 3.6 | 6 | 7 | 7 | 23.6 |
| Total | 16.1 | 19 | 14 | 10 | 59.1 |

TABLE-1FIG. 3 is a block diagram of a computer or a server 100 for system for spell checking and correction in accordance with an embodiment of the present disclosure. The server includes processors 110, and memory 120 operatively coupled to the bus 130.

The processor(s) 110, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 120 includes a plurality of subsystems and a plurality of modules stored in the form of executable program which instructs the processor 110 to perform the method steps illustrated in FIG. 1. The memory 120 is substantially similar to the system 10 of FIG. 1. The memory 120 has following subsystems: the processing subsystem 15 includes the digital asset data collection module 20, the digital asset data maintenance module 30, the data assessment module 50 and the digital asset score generation module 60.

The processing subsystem includes a digital asset data collection module 20 configured to collect information corresponding to a plurality of data parameters associated with the one or more digital assets from a plurality of source data points to create a database. The processing subsystem also includes a digital asset data maintenance module 30 configured to store the information collected by the digital asset data collection module 20 into a blockchain 40. The digital asset data maintenance module 30 is also configured to update the information stored in the blockchain 40 dynamically using a plurality of learning based data upgradation techniques and a plurality of external sources. The processing subsystem further includes a data assessment module 50 configured to assess the information, updated by the data maintenance module 30, stored in the blockchain 40 to obtain a plurality of research products. The data assessment module 50 is also configured to generate a machine assessment score based on the information assessed. The memory 120 further includes a digital asset score generation module 60 configured to generate an aggregated score by receiving the machine assessment score generated by the data assessment module 50 and one or more user assessment scores.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, hybrid blockchain and application programs, for performing tasks, or defining abstract data types or low-level hardware contexts. Executable program stored on any of the above-mentioned storage media may be executable by the processor(s) 110.

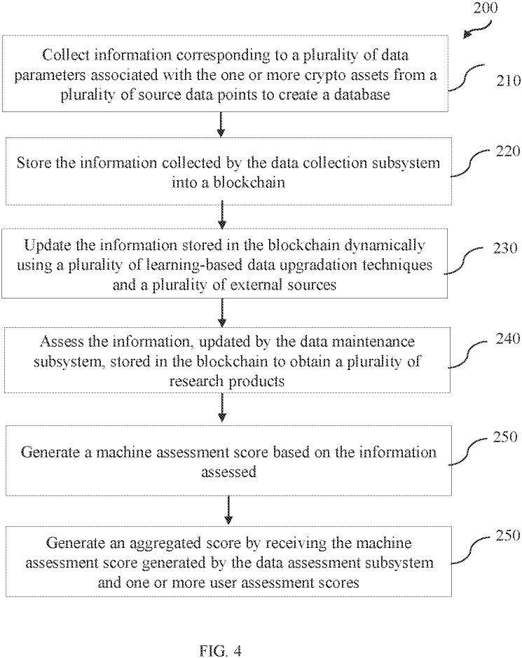

FIG. 4 is a flow chart representing the steps involved in a method 200 for assessment of digital assets in accordance with an embodiment of the present disclosure. The method 200 includes collecting information corresponding to data parameters associated with the one or more digital assets from source data points to create a database in step 210. In one embodiment, collecting information corresponding to data parameters associated with the one or more digital assets may include collecting information corresponding to data parameters associated with the one or more digital assets by a digital asset data collection module.

In one embodiment, collecting information corresponding to data parameters associated with the one or more digital assets may include collecting information corresponding to data parameters associated with at least one of legal information, financial information, technology information, funding information, due diligence information, trade information or a combination thereof. In a specific embodiment, collecting information corresponding to data parameters associated with the one or more digital assets may include collecting information corresponding at least one of legal parameter, team related parameter, token economics related parameter, general project related parameter, funding information related parameter, market and industry analysis related parameter, technology and trade information related parameter, organization project related parameter or a combination thereof.

The method 200 further includes storing the information collected by the data collection module into a blockchain in step 220. In one embodiment, storing the information collected by the data collection module into a blockchain may include storing the information collected by the digital asset data collection module into a blockchain by a digital asset data maintenance module. The method 200 includes updating the information stored in the blockchain dynamically using learning-based data upgradation techniques and various external sources in step 230. In one embodiment, updating the information stored in the blockchain dynamically may include updating the information stored in the blockchain dynamically by the digital asset data maintenance module.

In one embodiment, updating the information stored in the blockchain dynamically using learning-based data upgradation techniques may include updating the information stored in the blockchain dynamically using at least one of artificial intelligence techniques, machine learning techniques or a combination thereof. In a specific embodiment, updating the information stored in the blockchain dynamically using various external sources may include updating the information stored in the blockchain dynamically using at least one of web crawling, feedbacks, manual entry, opinions, polls or a combination thereof.

Furthermore, the method 200 includes assessing the information, updated by the crypto and digital asset data maintenance module, stored in the blockchain to obtain multiple research products in step 240. In one embodiment, assessing the information stored in the blockchain to obtain multiple research products may include assessing the information stored in the blockchain to obtain multiple research products by a data assessment module. In a specific embodiment, assessing the information stored in the blockchain to obtain multiple research products may include assessing the information stored in the blockchain to obtain at least one of a rating report, a research report, an intelligence report, an educational report, market indices report, on demand service report, a blockchain forensics report, a transaction tracing report or a combination thereof.

In one embodiment, the method 300 may include verify an integrity of the information stored in the blockchain using a hash validation technique. The data is verified and maintained on the blockchain which makes the information stored more reliable and immutable in nature. The information stored on the blockchain is maintained in several nodes that have the same copy of the previous data. Hence, if there is any attempt of manipulation in the database, all the nodes must accept the change. If the majority of the nodes accept the change, the change is entered in the blockchain, but if not, that attempt is failed. This makes the blockchain data immutable because once the data is entered by approval of the majority of nodes, the data cannot be reversed.

Moreover, the method 200 further includes generating a machine assessment score based on the information assessed in step 250. In one embodiment, generating a machine assessment score based on the information assessed may include generating a machine assessment score based on the information assessed by the data assessment module. The information assessed is verified and evaluated by automation which includes automatic scoring methods designed in the rating model. The parameters entered in the model keep changing as per the changes in the industry as per the economic political and financial situations. Such rating is then entered in the projects column and is sent to one or more evaluators for further verification. In such an embodiment, the method 200 may include receiving one or more user scores evaluated by the one or more evaluators. The one or more user scores may be evaluated by based on understanding of the one or more evaluator as per expertise and professional skills and enters the score into score column of the data assessment module.

In addition, the method 200 includes generating an aggregated score by receiving the machine assessment score generated by the data assessment module and one or more user assessment scores evaluated by the one or more evaluators in step 260. In one embodiment, generating an aggregated score by receiving the machine assessment score and one or more user assessment scores may include generating an aggregated score by receiving the machine assessment score and one or more user assessment scores by a digital asset score generation module. In some embodiments, generating an aggregated score may include generating the aggregated score based on a concatenation of the machine generate assessment score and the one or more user assessment scores. In such an embodiment, generating the aggregated score may include converting into alphabetical rating chart for an easy understanding of the rating. In one embodiment, the method 200 may include calculating a change in the aggregated score based on the information updated by the data maintenance module.

The system includes a processing subsystem which is hosted on a server. The server enables less hardware to be required since data is accessed from the server and computing on the server which result in reduced processing time. Moreover, the system requires less memory and processing power as the system stores the data on the blockchain which encrypt the data itself and save processing power of the system processing subsystem and thereby enabling technical advancement.

Various embodiments of the system and method for assessment of digital assets described above enables a scalable approach to systematically research and ascertain a project, service or framework mainly using a unique and weighted methodology to develop research-backed rating and other products. The method uses blockchain technology to store, evaluate and verify data in order to make the process more reliable, immutable and decentralized. The system is then enabled to track the progress of the data company and its development using artificial intelligence-based algorithms for a unique networking arrangement. Such clean process and reliable data can be used to enable better functionality of other data-backed products.

Additionally, the system includes a unique matrix which keeps in mind the traditional methods, as well as new processes technologies and ideology, By doing so on unregulated or mal practices can be reduced and the market investors and the entire ecosystem can benefit from genuine emerging technology projects as not everyone has expertise about how this industry functions. Accordingly, any consensus process, where different nodes on the distributed network must agree on any changes made to the ledger, may be simplified and overall performance of the ledger may be increased. The system may be implemented in web as well as in mobile devices.

It will be understood by those skilled in the art that the foregoing general description and the following detailed description are exemplary and explanatory of the disclosure and are not intended to be restrictive thereof.

While specific language has been used to describe the disclosure. any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

I claim:

1. A system for assessment of one or more digital assets comprising:
a processing subsystem hosted on a node, wherein the processing subsystem comprises:
a digital asset data collection module configured to collect information corresponding to a plurality of data parameters associated with the one or more digital assets from a plurality of source data points to create a database:
a digital asset data maintenance module configured to:
store the information collected by the digital asset data collection
module into a blockchain; and
update the information stored in the blockchain dynamically using a plurality of learning based data upgradation techniques and a plurality of external sources;
a data assessment module configured to:
assess the information, updated by the digital asset data maintenance module, stored in the blockchain to obtain a plurality of research products and a plurality of other products: and
generate a machine assessment score based on the information assessed; and
a digital asset score generation module configured to generate an aggregated score by receiving the machine assessment score generated by the data assessment module and one or more user assessment scores.

2. The system as claimed in claim 1, wherein the one or more digital assets comprises at least one of legal information, financial information, technology information, funding information, due diligence information, trade information or a combination thereof.

3. The system as claimed in claim 1, wherein the plurality of data parameters comprise at least one of legal parameter, team related parameter, token economics related parameter, general project related parameter, funding information related parameter, market and industry analysis related parameter, technology and trade information related parameter, organization project related parameter or a combination thereof.

4. The system as claimed in claim 1, wherein the plurality of external sources comprises at least one of web crawling, feedbacks, manual entry, opinions, polls or a combination thereof.

5. The system as claimed in claim 1, wherein the plurality of research products comprises at least one of a rating report, a research report, an intelligence report, an educational report, market indices report, on demand service report, a forensics report, a transaction tracing report, an exclusive individual database or a combination thereof.

6. The system as claimed in claim 1, wherein the data assessment module is configured to verify an integrity of the information stored in the blockchain using a hash validation technique.

7. The system as claimed in claim 1, wherein the digital asset score generation module is configured to generate the aggregated score based on a concatenation of the machine generate assessment score and the one or more user assessment scores.

8. The system as claimed in claim 1, wherein the digital score generation module is configured to calculate a change in the aggregated score based on the information updated by the digital asset data maintenance subsystem.

9. A method for assessment of one or more digital assets comprising:
collecting, by a digital asset data collection module, information corresponding to a plurality of data parameters associated with the one or more digital assets from a plurality of source data points to create a database;
storing, by a digital asset data maintenance module, the information collected by the data collection module into a blockchain;
updating, by the digital asset data maintenance module, the information stored in the blockchain dynamically using a plurality of learning based data upgradation techniques and a plurality of external sources;
assessing, by a data assessment module, the information, updated by the data maintenance module, stored in the blockchain to obtain a plurality of research products and a plurality of other products:
generating, by the data assessment module, a machine assessment score based on the information assessed; and
generating, by a digital asset score generation module, an aggregated score by receiving the machine assessment score generated by the data assessment module and one or more user assessment scores.

10. The method as claimed in claim 1, comprising verifying, by the data assessment module, an integrity of the information stored in the blockchain using a hash validation technique.
